(19) United States
(12) Patent Application Publication
(10) Pub. No.: US 2009/0025590 A1
(43) Pub. Date: Jan. 29, 2009

(54) Track-Laying Apparatus for Laying Easter Bunny Tracks, Other Track-Laying Apparatuses and Track-Laying Methods

(76) Inventor: David W. Hebda, Fairfax Station, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/782,945

(22) Filed: Jul. 25, 2007

(51) Int. Cl. B41K 1/56

(52) U.S. Cl. 101/405; 101/368; 239/327

(57) ABSTRACT

Easter bunny tracks may be laid onto the ground using a track-laying device to dispense flour or another material contrasting with the ground. Other desired track shapes (such as tracks of Santa's reindeer) may be laid using a track-laying device and suitable dispensed material. A handle with a ground-contacting rubber tip makes the device especially convenient to operate.

### FIELD OF THE INVENTION

This invention relates to the field of powder dispensers and more particularly to hand-held dispensers.

### BACKGROUND OF THE INVENTION

Many communities and families with children that celebrate Easter additionally enjoy putting into action the myth of the Easter Bunny. Children in many families awake on Easter to find a basket “left by the Easter Bunny.” Many communities hold activities attended by a large, costumed “Easter Bunny.”

### SUMMARY OF INVENTION

The present inventor has discovered that the family fun of the myth of the Easter Bunny may be further enhanced by creating additional evidence that the Easter Bunny has visited, namely by creating tracks on a ground surface that simulate Easter Bunny tracks. The invention may be used to create tracks of the Easter Bunny and also to create tracks of other mythical figures such as, e.g., the Easter Bunny, Santa's reindeer, Santa, etc.

In a first preferred embodiment, the invention provides a track-laying device, comprising: a container (such as, e.g., a lidded container, etc.) for holding a powdery, dispensable material (such as, e.g., flour) of a color contrasting with a surface below on which the material is to be dispensed; and a pattern of at least one aperture in the container through which the material is dispensable, the pattern having a shape such that material dispensed lands onto the surface below in a desired shape (such as, e.g., a pattern shaped such that material dispensed through the aperture(s) lands onto the surface below in a shape selected from the group consisting of: an Easter bunny track; a reindeer hoof track; and a shamrock); including but not limited to inventive devices comprising a handle and a ground-contacting rubber part; inventive devices comprising a powdery, dispensible material in the container; inventive devices wherein the container holds flour; inventive devices wherein the device in an unloaded condition consists essentially of the container, the handle and the ground-contacting rubber part; inventive devices comprising a lid screwable onto and unscrewable from the container; and other inventive devices.

The invention in another preferred embodiment provides a method for laying tracks on a ground surface, comprising: within a track-laying device (such as, e.g., a track-laying device manually operable by a human operator) comprising a pattern comprising at least one aperture, disposing a quantity of a powdery, dispensable material of a color contrasting with a surface below on which the material is to be dispensed; operating the track-laying device (such as, e.g., operating by a human operator manually), whereby material is released from the device onto the surface below to land in a desired track shape; such as, e.g., inventive track-laying methods in which the step of operating the track-laying device is performed manually and comprising bouncing a rubber part that is part of the track-laying device against a ground surface; inventive methods comprising laying of tracks that simulate tracks of a mythical figure (such as, e.g., the Easter Bunny; Santa's reindeer; Santa; etc.); inventive methods comprising laying of tracks that simulate tracks of a school mascot; inventive methods comprising laying of tracks that simulate a real animal; etc.

In a further preferred embodiment the invention provides a dispenser for a powdery material, comprising: a container in which may be contained a powdery material, the container having at least one pattern of at least one aperture through which the material exits, each aperture sized and shaped to release little or no material when the container is relatively stationary; and a ground-contacting part comprising a ground-contacting rubber member; such as, e.g., inventive dispensers wherein the ground-contacting part comprises an extension member connected at a first end to a bottom of the container and at a second end to the ground-contacting rubber member; inventive dispensers comprising a handle part connected at a first end to the container; inventive dispensers consisting essentially of: the container, the ground-contacting part comprising the ground-contacting rubber member, an extension member connected at a first end to a bottom of the container and a second end to the ground-contacting member, and a handle part connected at a first end to the container; inventive dispensers comprising apertures sized and shaped that material exits when the ground-contacting rubber member is bounced against a ground surface; inventive dispensers wherein material exits the container due to gravity and due to forces generated when the ground-contacting rubber member is bounced against a ground surface; and other inventive dispensers.

### BRIEF DESCRIPTION OF THE DRAWINGS

The invention may be appreciated with reference to the following figures, without the invention being limited to the figures:

FIG. 1 is a perspective view of an inventive track-laying apparatus in a first embodiment.

FIG. 1A is a cross-sectional view of the bottom 1A of container 1 in FIG. 1.

FIG. 2 is an example of a ground surface onto which has been laid tracks from an inventive track-laying apparatus, not drawn to scale.

FIG. 3 is a perspective view of an inventive track-laying apparatus in a second embodiment.

### DETAILED DESCRIPTION OF A PREFERRED EMBODIMENT

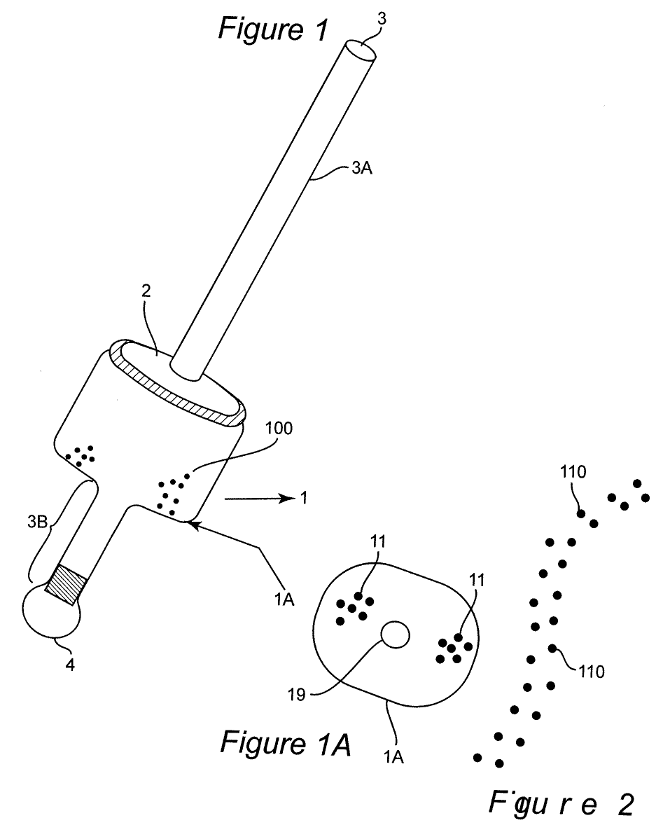

Referring to FIG. 1, an inventive track-laying apparatus is shown. The apparatus comprises a container 1 suitable for holding a quantity of to-be-dispensed material. Preferably the container 1 is clear (such as, e.g., a clear plastic container), so that the level of to-be-dispensed material may be seen. Preferably the container 1 is refillable, such as a lidded container with the lid 2 being removable (such as a screwable and unscrewable lid). It should be appreciated that in FIG. 1 the round-shape of container 1 is illustrative and that the invention is not particularly limited to such a shape of containers 1.

An example of making an inventive track-laying apparatus is, e.g., to use a lidded clear plastic container as the container 1 and to make holes in the container 1 for receiving a handle member (such as, e.g. a piece of broom handle approximately 4 feet in length). The apparatus comprises a hand-contacting part 3A and a near-ground part 3B which in a preferred example are parts of a unitary handle 3. However, it should be appreciated that the hand-contacting part 3A is not required to be unitary with the near-ground part 3B and that in some embodiments, parts 3A and 3B may be separate. A preferred example of a length of the near-ground part 3B of the handle 3 is about 6-8 inches, but the length of the near-ground part 3B is not particularly limited. The shape and structure of part 3B is not particularly limited.

Preferably, the near-ground part 3B terminates in a ground-contacting member 4 which preferably is made of rubber or a rubbery material, such as, e.g., a rubber ball. In a simple embodiment, a rubber ball may be fastened (such as, e.g., duct-taped, etc.) to a stick to make the handle 3 at part 3B terminating in a ground-contacting member 4.

In a non-limiting example of the handle 3, the handle 3 extends in a unitary piece within and through the container 1 and out the bottom end 1A of the container 1 where it is near-ground part 3B of the handle 3. When a unitary handle 3 is used, the handle 3 passes through holes in the lid 2 and bottom 1A of the container 1. Where the near-ground part 3B of handle 3 passes through the bottom 1A of the container 1, preferably the opening or space around the handle 3 is sealed or limited, such as by applying duct tape.

In FIG. 1, to-be-dispensed material 100 (such as, e.g., flour, etc.) is shown in a representational manner as dots within the container 1 and leaving the container 1. The to-be-dispensed material 100 is selected for color contrast with the ground surface onto which the to-be-dispensed material 100 is to be dispensed. For example, onto a grassy surface, white flour may be used as a to-be-dispensed material 100. However, it will be appreciated that dispensing white flour onto a snow-covered white surface would not provide good contrast.

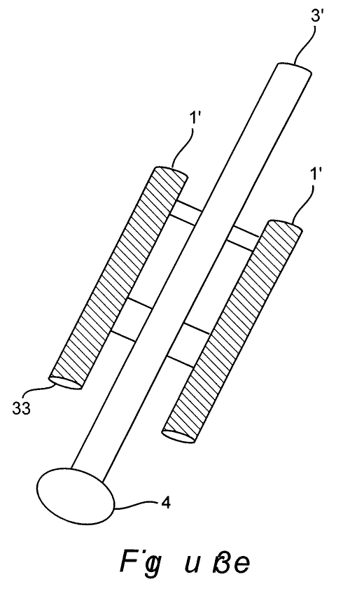

The bottom 1A of the container 1 is not particularly limited and the bottom 1A may, e.g., be relatively flat, contoured, etc. The container 1 is required to have holes or apertures 11 through which the to-be-dispensed material 100 can exit the container 1. The number or pattern of holes or apertures is not particularly limited. In a preferred example, a pattern consisting of a left set of holes and a right set of holes is used, through which to-be-dispensed material exit to drop onto the ground below forming two sets of parallel “paw prints” (see, e.g., FIG. 2) when the device of FIG. 1 is bounced along a ground surface. When a left-right pattern is used on the bottom 1A, the number of holes on the left and right sides may or may not be equal. In one prototype made and used by the inventor, one side of the pattern has 10 holes and the other side of the pattern has 11 holes. When a left-right pattern is used on the bottom 1A, the right and left sides are otherwise not required to be identical or to differ, with regard to inter-hole spacing, number of holes, etc.

It will be appreciated that if too-big a size is used for individual holes in holes 11, then the to-be-dispensed material 100 will drop out wildly and in too-great quantities. On the other hand, if too-small a size is used for individual holes in holes 11, then the to-be-dispensed material 100 will not exit well. When a clear plastic container is used as the container 1 and white flour is used as the to-be-dispensed material 100, drilled 1/4 inch holes are a preferred example of a size to use for individual holes. The holes or apertures 11 are preferably sized and shaped that material exits when the ground-contacting rubber member 4 is bounced against a ground surface.

Region 19 (FIG. 1A) may be a hole or an attachment point depending on whether a unitary handle 3 is used or whether parts 3A and 3B (FIG. 1) are non-unitary. When a unitary handle 3 (FIG. 1) is used, region 19 in the bottom 1A of the container 1 comprises a hole through which the handle 3 passes. Alternately, when a part 3B is used which is non-unitary with part 3A, region 19 in the bottom 1A of the container 1 is where part 3B meets the container 1.

Referring to FIG. 2, which is not shown to scale with FIGS. 1 or 1A, it should be appreciated that each “paw print” 110 is a collection of dispensed material 100 that exited from a track-laying apparatus such as an apparatus in FIG. 1. In the case of the tracks in FIG. 2 being laid by the apparatus of FIG. 1, each paw print 110 is a collection of dispensed material 100 that exited from the container 1 via holes 11 (FIG. 1A).

Holes 11, part 3B, and to-be-dispensed material 100 should be chosen to cooperate in order to produce a desired track pattern on a ground surface (see, e.g., FIG. 2). It should be taken into account, for example, what the desired track (see, e.g., FIG. 2) is wanted to suggest, e.g., Easter bunny tracks, Santa's reindeer tracks, the tooth fairy's tracks, Santa's tracks, etc.

It should be appreciated that the removable top 2 (FIG. 1) is shown where it is by way of illustrative example and that the invention includes other refillable configurations such as, containers 1 with side openings, etc. When the top 2 (FIG. 1) is an unscrewable lid in which has been formed a hole through which a unitary handle is disposed, it will be appreciated that the lid may slide up part 3A to expose the interior of the container 1 so that the container 1 may be refilled.

Referring to FIG. 3, an alternative construction of an inventive track-laying apparatus or device is shown. Related parts in FIG. 3 to parts in FIG. 1 are given similar numbers. Handle 3′ in FIG. 3 preferably is a unitary piece, preferably like a broomstick-handle. In FIG. 3, handle 3′ at its ground-contacting end has a ground-contacting member 4 which preferably is made of rubber or a rubbery material, such as, e.g., a rubber ball. Each container 1′ holds to-be-dispensed material 100 and are joined to handle 3′. A container 1′ at an end closest to the ground terminates in a screw-off cap 33. A screw-off cap comprises a stencil or a pattern which may be a pattern of holes 11 as in FIG. 1A or may be another pattern, such as a shamrock stencil pattern, a paw print stencil pattern, a high school logo, reindeer hooves, a jack o'lantern pattern, etc.

Examples of to-be-dispensed material 100 are, e.g., flour, dyed flour, sawdust, dyed sawdust, seed, etc.

While the invention has been described in terms of preferred embodiments, those skilled in the art will recognize that the invention can be practiced with modification within the spirit and scope of the appended claims.

What I claim as my invention is:

1. A track-laying device, comprising:
a container for holding a powdery, dispensable material of a color contrasting with a surface below on which the material is to be dispensed; and
a pattern of at least one aperture in the container through which the material is dispensable, the pattern having a shape such that material dispensed lands onto the surface below in a desired shape.

2. The device of claim 1, comprising a handle and a ground-contacting rubber part.

3. The device of claim 1, comprising a powdery, dispensible material in the container.

4. The device of claim 3, wherein the container holds flour.

5. The device of claim 1, wherein the pattern is shaped such that material dispensed through the aperture lands onto the surface below in a shape selected from the group consisting of: an Easter bunny track; a reindeer hoof track; and a shamrock.

6. The device of claim 2, wherein the device in an unloaded condition consists essentially of the container, the handle and the ground-contacting rubber part.

7. The device of claim 1, wherein the container is a lidded container.

8. The device of claim 1, comprising a lid screwable onto and unscrewable from the container.

9. A method for laying tracks on a ground surface, comprising:
within a track-laying device comprising a pattern comprising at least one aperture, disposing a quantity of a powdery, dispensable material of a color contrasting with a surface below on which the material is to be dispensed;
operating the track-laying device, whereby material is released from the device onto the surface below to land in a desired track shape.

10. The track-laying method of claim 9, the step of operating the track-laying device being performed manually and comprising bouncing a rubber part that is part of the track-laying device against a ground surface.

11. The track-laying method of claim 9, the track-laying device being manually operable by a human operator.

12. The method of claim 9, comprising laying of tracks that simulate tracks of a mythical figure.

13. The method of claim 12, wherein the mythical figure is selected from the group consisting of the Easter Bunny; Santa's reindeer; and Santa.

14. A dispenser for a powdery material, comprising:
a container in which may be contained a powdery material, the container having at least one pattern of at least one aperture through which the material exits, each aperture sized and shaped to release little or no material when the container is relatively stationary; and
a ground-contacting part comprising a ground-contacting rubber member.

15. The dispenser of claim 14, wherein the ground-contacting part comprises an extension member connected at a first end to a bottom of the container and at a second end to the ground-contacting rubber member.

16. The dispenser of claim 14, comprising a handle part connected at a first end to the container.

17. The dispenser of claim 14, consisting essentially of:
the container,
the ground-contacting part comprising the ground-contacting rubber member,
an extension member connected at a first end to a bottom of the container and a second end to the ground-contacting member, and
a handle part connected at a first end to the container.

18. The dispenser of claim 14, the apertures being sized and shaped that material exits when the ground-contacting rubber member is bounced against a ground surface.

19. The dispenser of claim 17, wherein material exits the container due to gravity and due to forces generated when the ground-contacting rubber member is bounced against a ground surface.
